(19) United States
(12) Patent Application Publication
(10) Pub. No.: US 2018/0355280 A1
(43) Pub. Date: Dec. 13, 2018

(54) CANDLE CONVERSION DEVICE

(71) Applicant: WobbleWorks, Inc., Wilmington, DE (US)

(72) Inventors: Maxwell BOGUE, Hong Kong (CN); Sing Sen Robin WONG, Hong Kong (CN); Thomas WALKER, Shenzhen City (CN)

(21) Appl. No.: 15/619,384

(22) Filed: Jun. 9, 2017

(51) Int. Cl. C11C 5/02

(52) U.S. Cl. CPC C11C 5/023

(57) ABSTRACT

A candle conversion device is provided that can allow for complete melting and conversion of candle wax to produce a new wax object or candle. The device can include a thermal sleeve couplable with a candle support having a candle engagement member and a drainage passage, which can direct melted wax toward a wax mold having an inner wax cavity with a shape profile to which the melted wax conforms, the thermal sleeve and the candle support configured to conduct and/or radiate thermal energy received from the candle flame between portions of the device and candle.

### BACKGROUND

### Field of the Inventions

The present inventions relate to devices and methods for providing efficient melting and capturing of candle wax, and more specifically, to mechanisms for capturing, conserving, and directing energy to provide complete melting and recycling of candle wax.

### Description of the Related Art

Recycling candle wax is the process of capturing and repurposing melting candle wax, for example, to make a new candle or other object.

When a candle is burned or consumed, a portion of the candle wick is ignited to produce a flame. The flame radiates heat, which melts the adjacent candle wax. A portion of the melted wax is drawn toward the flame by capillary action, where the wax is vaporized. Another portion of the melted wax flows away from the flame, typically moving along an outer surface of the candle toward the candle's base.

### SUMMARY

In accordance with at least some embodiments disclosed herein is the realization that although melted wax can be captured or converted into a new candle, certain problems occur in wax collection devices. For example, the melting wax can be directed into a receptacle of a wax collection device, in which a new candle wick is placed so that the wax can collect around the candlewick during candle formation. However, there are certain problems in ensuring efficient wax flow and collection, such as the melted wax solidifying and accumulating along the outer surface of the wax collection device, candle, or candle holder before the wax flows to an optimal position so as to not only be captured or directed to a receptacle of the wax collection device, but to also create a well-formed new candle with a consistent density and surface finish.

For example, some embodiments disclosed herein relate to the realization that when the candle's flame is extinguished, such as when the candle is snuffed out or completely consumed, the source of thermal energy that causes the wax to melt is lost. When the source of thermal energy is lost, the recently melted wax rapidly solidifies, giving off its heat through conduction and convection to the ambient environment. This recently melted wax solidifies on the wax collection device, candle, or candle holder used to direct the melted wax into the receptacle before the wax can be received in the receptacle.

Some embodiments provide candle conversion devices in which the melted wax from a candle can be converted to produce a new candle by capturing the melted wax in a receptacle or wax mold of the candle conversion device. Further, as noted, some embodiments disclosed herein involve the realization that unfinished wax flow and incomplete recycling can occur because the melted wax begins to solidify when the melted wax flows along portions of device that direct the wax into the wax mold. Further, some embodiments include the realization that when the candle wick is completely consumed and the candle flame extinguishes, some unmelted candle wax remains, but heat will immediately begin leaving the system and the recently melted wax will begin to solidify. This can result in candle wax stuck to the candle holder and the candle conversion device, causing incomplete recycling of the candle wax.

Accordingly, in some embodiments, a candle conversion device is provided that can facilitate complete melting and recycling of candle wax. For example, some embodiments can facilitate and entire melt of the wax of a lit candle that is supported by the device. As such, the present disclosure permits the wax of a candle to be completely melted and directed to the wax mold of the candle conversion device for recycling into a new candle.

The device of the present disclosure can operate far more efficiently compared to prior devices used to capture melted wax from a candle using conventional wax molds and support structures. For example, some embodiments can comprise one or more heat recycling components, such as a sleeve and/or candle support of the candle conversion device, that can receive, absorb, and/or store thermal energy radiating from the flame of a candle as the candle burns and conduct and/or radiate the thermal energy back to the wax of the candle. The heat recycling component(s), however formed or structured into the candle conversion device, can operate as a heat sink, a heat radiator, and/or a heat conductor. The thermal energy retained by the heat recycling component (e.g., the sleeve, candle support, and/or other structure of the candle conversion device) can be redirected to the candle wax to melt or maintain the wax in a melted state so that it can move through a drainage passage toward a wax cavity of the wax mold.

Additionally, some embodiments can use interchangeable wax molds with wax cavities that receive the melted wax to produce a new candle. The interchangeable wax molds have a wax cavity with a profile shape that produces a wax object in that shape. Because the wax molds are interchangeable with the candle conversion device, a variety of wax objects and candles having different shapes and sizes can be produced.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 is a front perspective view of a candle conversion device and a candle, according to some embodiments.

FIG. 2 is an exploded view of a candle conversion device and a candle, according to some embodiments.

FIG. 3 is a top view of a candle conversion device, according to some embodiments.

FIG. 4 is a cross-section view of a thermal sleeve for a candle conversion device, according to some embodiments.

FIG. 5 is a cross-section view of a candle support for a candle conversion device, according to some embodiments.

FIG. 6 is a cross-section view of a thermal sleeve and a candle support for a candle conversion device, according to some embodiments.

FIG. 7 is a partially exploded cross-section view of a candle conversion device, according to some embodiments.

FIGS. 8A and 8B are cross-section detail views of a candle conversion device, according to some embodiments.

FIG. 9 is a graph illustrating candle support structure temperature relative to candle height for a candle conversion device, according to some embodiments.

FIG. 10 is a graph illustrating candle burning time relative to candle melting speed for a candle conversion device, according to some embodiments.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

Candles comprise a cylinder or block of wax or tallow with a wick that is lit to produce light and/or heat as it burns. Although the present disclosure refers to a candle, other substances or sources providing a meltable material may be implemented.

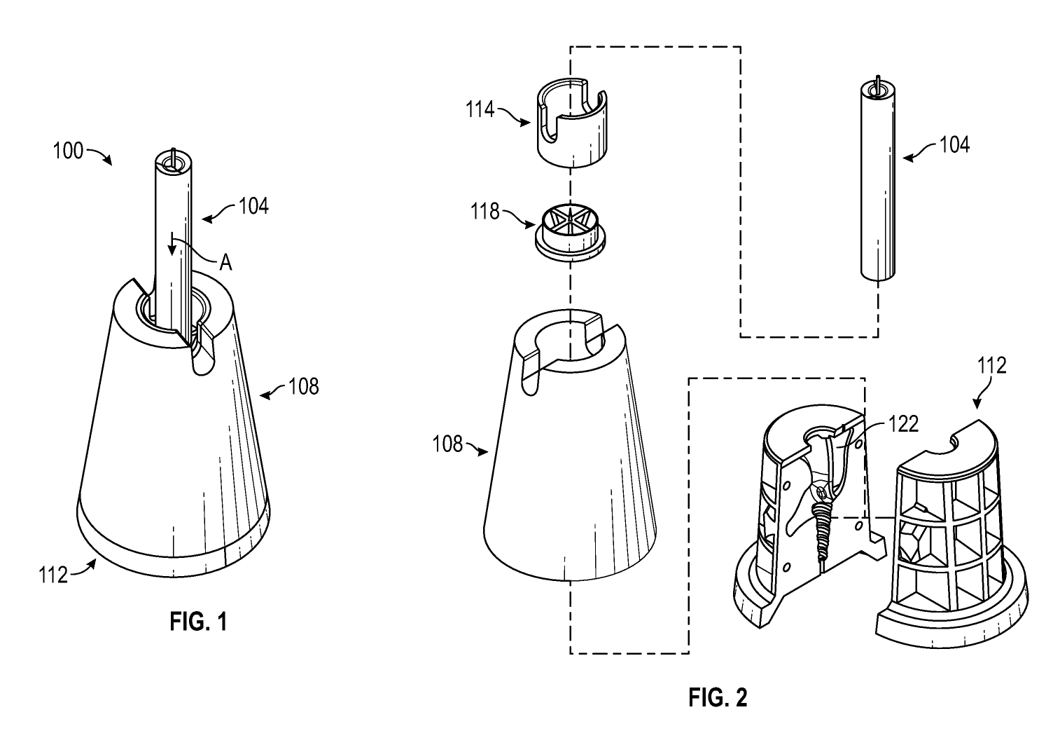

Referring now to the figures, FIG. 1 illustrates a candle conversion device 100 according to some embodiments of the present disclosure. A candle 104 is coupled with the candle conversion device 100. When the candle wick is ignited, the melted wax moves in the direction of arrow A toward a housing 108 of the candle conversion device. The melted wax is then directed toward a wax mold 112 positioned within the housing 108, and received into a wax cavity of the wax mold.

FIG. 2 illustrates an exploded view of the candle conversion device 100 of FIG. 1. The candle conversion device 100 can comprise one or more heat recycling components that can facilitate full and/or even melting of a candle supported by the device 100. For example, the candle conversion device 100 can include a heat recycling component, such as a thermal sleeve 114 and/or a candle support 118. The thermal sleeve 114 and the candle support 118 can be coupled together and positioned in a top portion of the housing 108. As discussed further below, the thermal sleeve 114 can operate as a heat reflector, heat storage, and/or heat recycling component that facilitates full and even melting of the candle 104 supported by the candle support 118. The thermal sleeve 114 can take heat from a burning candle and return the heat to the wax of the candle via heat transfer methods, such as conduction, radiation, and/or convection.

The wax mold 112 can have one or more portions that are coupled together and positioned in a portion of the housing 108. Before inserting the wax mold 112 into the housing 108, a new candle wick can be positioned in a wax cavity 122 of the wax mold. The wax mold 112 is positioned in a bottom portion of the housing 108 so that a passage extends between the thermal sleeve 114, the candle support 118, and the wax cavity 122 of the wax mold.

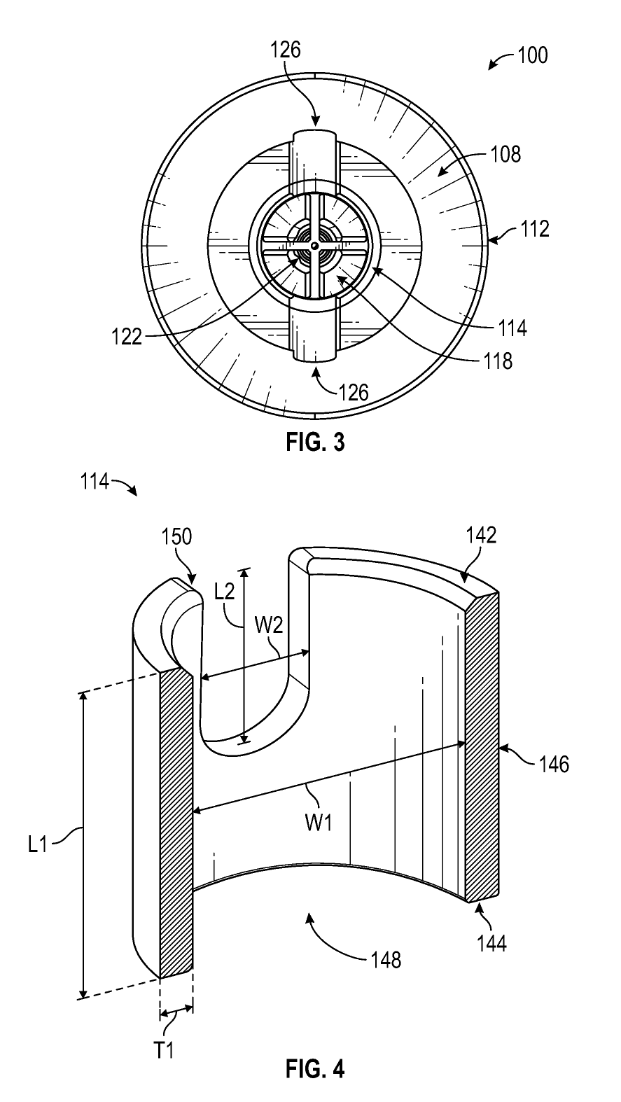

The passage between the thermal sleeve 114, the candle support 118, and the wax cavity 122 of the wax mold is illustrated in the top view of the candle conversion device 100 in FIG. 3. A candle, which is not illustrated here for clarity, can be engaged against the candle support 118 so that a portion of the candle extends through an inner lumen of the thermal sleeve 114. The candle support 118 forms a drainage passage that permits melted wax to move along the passage between the candle support 118 and the wax cavity 122 of the wax mold. When the candle conversion device 100 is assembled, the candle support 118 is aligned with the wax mold 112 so that the drainage passage is open to the wax cavity 122 of the wax mold.

As the melted wax moves along the outer surface of the candle and through the conduction sleeve 114, the melted wax contacts the candle support 118 and is directed toward the wax mold 112. The melted wax can contact an inner surface of the candle support 118 that forms a portion of the drainage passage, where it is directed or funneled through an opening of the wax mold into the wax cavity 122. Within the wax mold 112, the melted wax conforms to a shape or profile of the wax cavity 122. Here, for example, the wax cavity 122 has a profile shaped as a unicorn.

To facilitate burning of the candle when the flame is within the inner lumen of the thermal sleeve 114, the candle conversion device 100 can include a ventilation feature 126. The ventilation feature 126 permits movement of air between an ambient environment adjacent to an outer surface of the candle conversion device 100, and the inner lumen 148 of the thermal sleeve 114. As the candle burns, the height of the candle is reduced. When the height of the candle is less than a distance between the candle support 118 and a top end portion of the thermal sleeve 114, the flame is positioned within the inner lumen of the thermal sleeve 114 where ambient oxygen, necessary for combustion, is reduced relative to the ambient environment outside of the candle conversion device 100. The ventilation feature 126 permits ambient air to be drawn toward the inner lumen where it is consumed by combustion, thereby permitting the candle to continue burning.

In contrast to a candle without the candle conversion device 100, where ambient air is typically drawn toward the candle from the surrounding area by convection, the ventilation feature 126 of the candle conversion device 100 can alter the flow of ambient air toward the candle. For example, the cross-sectional width and/or profile of the ventilation feature 126 can be selected so that the velocity of air traveling toward the candle through the ventilation feature 126 is increased, relative to a candle without the candle conversion device 100. The increased velocity of air traveling toward the candle can cause the candle flame to become unsettled, increasing the rate consumption and/or melting of the candle, and increasing the amount of heat moving toward the candle support 118.

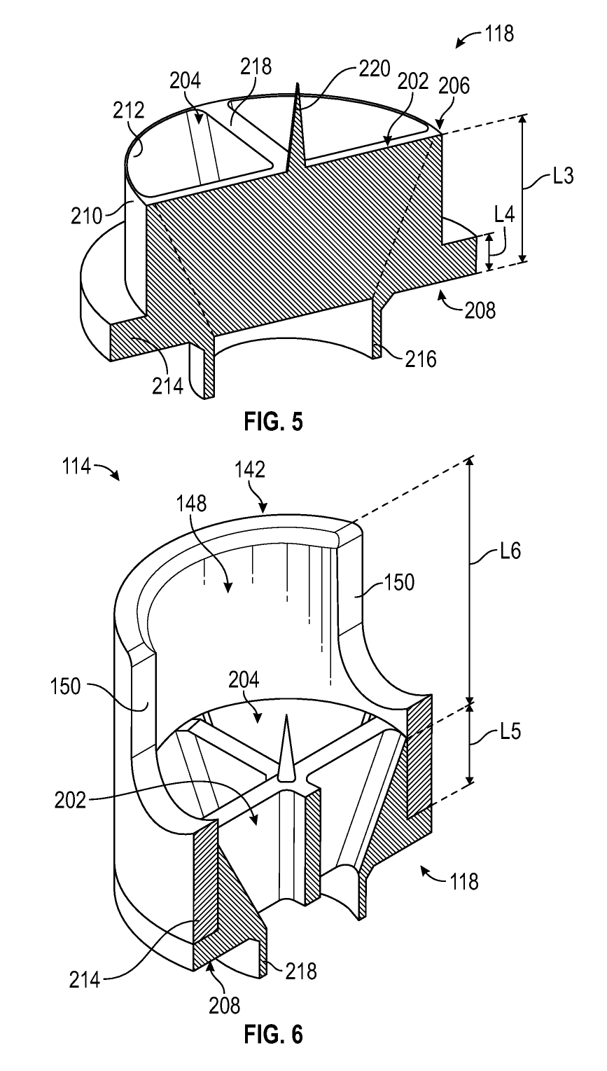

Referring to FIGS. 2 and 4, the thermal sleeve 114 can be shaped to extend around a portion of the candle and receive thermal energy emitted from the candle flame. The energy can be transferred between the thermal sleeve 114 and other portions of the candle conversion device 100 and/or the candle 104. At least some of the embodiments disclosed herein reflect the realization that energy can be transferred by conduction, convection, and/or radiation.

The thermal sleeve 114 can be shaped as a tube or ring having a top end portion 142 and a bottom end portion 144, and a wall 146 that extends between the top and bottom end portions. An inner surface of the wall 146 forms an inner lumen 148 that extends between top and bottom end portions.

A cross-sectional shape of the inner lumen 148 can include any of a regular or irregular shape, including for example, a circle, square, rectangle, and octagon. In some embodiments of the present disclosure, the cross-sectional shape of the inner lumen 148 corresponds to a cross-sectional shape of an outer surface of the candle. For example, a thermal sleeve 114 having a circular shape can be selected for use with a candle having circular cross-sectional shape, and a thermal sleeve 114 having a square shape can be selected for use with a candle having square cross-sectional shape. Although the cross-sectional shape of the thermal sleeve 114 can correspond with a cross-sectional shape of an outer surface of the candle, the thermal sleeve 114 and candle can have different cross-sectional shapes.

In some embodiments of the present disclosure, the thermal sleeve 114 can be any shape or structure configured to receive thermal energy from the candle flame. For example, the wall 148 can be shaped as a one or more columns and/or rings that are positioned adjacent to an outer surface of a candle positioned therein.

The thermal sleeve 114 can have a length L1, between the top and bottom end portions, and an cross-sectional width W1, between opposing portions of the inner surface of the wall 146. The length L1 can be at least about 0.25 inches and/or less than or equal to about 5 inches. Further, the length L1 can also be between about 0.5 inches and about 2.5 inches. The cross-sectional width W1 can be at least about 0.25 inches and/or less than or equal to about 4 inches, or between about 1 inch and 2 inches.

Additionally, the thermal sleeve 114 can have a wall thickness T1 between the inner and outer surfaces of the wall 146. The wall thickness T1 can be at least about 0.03 inch and/or less than or equal to about 1 inch, or between about 1 inch and 2 inches. Optionally, the wall can have a thickness T1 that varies. For example, the wall thickness can taper between the top and bottom end portions of the wall 146, and/or around a circumference of the wall 146.

In some devices of the present disclosure, the thermal sleeve 114 has a the length L1 of about 1 inch, an inner cross-sectional width W1 of about 1 inch, and a wall thickness T1 of about 0.12 inch.

Although example dimensions for the thermal sleeve 114 are identified herein, the dimensions of the thermal sleeve 114 can be a ratio relative to a cross-sectional width or diameter of the candle. Further, other heat recycling components can be provided as single or multiple structures coupled to the candle conversion device 100. For example, the cross-sectional width W1 of the thermal sleeve can be at least about 10% and/or less than or equal to about 100% larger than the candle diameter. In some devices of the present disclosure, the cross-sectional width W1 of the thermal sleeve is about 25% larger than the candle diameter.

Optionally, the inner cross-sectional width W1 of the thermal sleeve can be approximately equal to the diameter of the candle. Where the width W1 and the diameter of the candle are be approximately equal, features of the candle conversion device 100, such as the ventilation feature 126, can be obstructed by the solid candle wax, but become unobstructed as the candle wax melts.

Optionally, a ventilation channel 150 of the thermal sleeve can form a portion of the ventilation feature 126 of the candle conversion device. The ventilation channel 150 permits movement of a gas into or out of the inner lumen 148. The ventilation channel 150 can couple with another portion of the ventilation feature 126 to permit movement of a gas between the inner lumen 148 and an area adjacent to an outer surface of the thermal sleeve 114.

The ventilation channel 150 extends through the wall 146 of the thermal sleeve, from the outer surface to the inner surface. The ventilation channel 150 can be shaped as an aperture through the wall 146, or as a notch that extends from an end portion of the thermal sleeve 114. The notch can extend from a first end portion toward a second end portion that is opposite the first end portion. Further, the thermal sleeve 114 can have two or more ventilation channels 150. As illustrated in FIGS. 2 and 6, the ventilation channels 150 can extend along opposing portions of the wall 146.

The ventilation channel 150 can have a length L2, between the top and bottom end portions, and an cross-sectional width W2. The length L2 can be at least about 0.1 inches and/or less than or equal to about 3 inches, or between about 0.4 inches and about 1 inch. The width W2 can be at least about 0.1 inches and/or less than or equal to about 2 inches, or between about 0.2 inches and about 1 inch. In some devices of the present disclosure, the ventilation channel 150 has a length L2 of 0.6 inch, and a width W2 of 0.4 inch. In some devices of the present disclosure, the cross-sectional width W2 of the ventilation channel is about the width of the candle flame. The cross-sectional width W2 can be selected relative to the candle wick width and/or relative to the width of the candle. In some embodiments of the present disclosure, the cross-sectional width W2 is 50% to 150% of the width of the candle.

Optionally, dimensions of the thermal sleeve 114 can be selected to achieve certain performance characteristics of the candle conversion device 100. For example, a thermal sleeve 114 having a small wall thickness T1, relative to the candle diameter, can be selected to retain less thermal energy, thereby slowing a rate of candle consumption. Alternatively, a thermal sleeve 114 having a large wall thickness T1, relative to the candle diameter, can be selected to retain more thermal energy, thereby increasing a rate of candle consumption. In some embodiments of the present disclosure, a wall of the thermal sleeve 114 can have a small wall thickness, relative to the candle diameter, thereby having less mass and permitting a rapid increase in temperature. The rapid increase in temperature results in the smooth flow of wax in contact with the wall.

Additionally, the size of the ventilation channel 150 can be selected to regulate the volume and/or velocity of gas permitted therethrough. For example, a smaller size ventilation channel 150 can be selected to restrict movement of gas toward the candle, thereby increasing a velocity of the gas moving toward the candle, and increasing a rate of candle consumption.

In some embodiments of the present disclosure, the ventilation channel 150 can be any shape or feature that permits movement of a gas between the inner lumen 148 and another portion of the candle conversion device 100 or ambient environment. For example, the ventilation channel can be any of a passage that extends through and/or along the wall 146, a porous portion of the wall 148, or a space between separated portions and/or layers of the wall 148. Optionally, the ventilation channel can be a separate passage or conduit of candle conversion device 100 that permits a gas to be directed to the inner lumen 148.

The thermal sleeve 114 can be formed of one or more materials. The material can have a thermal conductivity that is favorable to conducting heat, such as aluminum, copper, or brass. In some embodiments of the present disclosure, the thermal sleeve 114 can be formed of a material that comprises a thermal conductivity that provides insulating characteristics, such as polyurethane, fiberglass, and silicone. At least some of the embodiments disclosed herein reflect the realization that the thermal sleeve 114 can comprise portions having different materials. For example, an inner surface of the wall 146 can comprise a conductive material to receive and direct thermal energy from the candle flame, while an outer surface of the wall 146 can comprise an insulating material to absorb and/or retain the energy received from the candle 104 and prevent conduction of the energy to the housing 108.

Referring to FIGS. 2 and 5, the candle support 118 can be coupled with the candle conversion device 100 to mount a candle 104 in a position relative to the thermal sleeve 114. Further, the candle support 118 can conduct thermal energy between the conduction sleeve 114 and candle 104, and can direct melted wax from the candle 104 toward the wax mold 112.

The candle support 118 is shaped as a tube or ring having a candle engagement member 202 and a drainage passage 204. The candle support 118 extends between a top end portion 206 and a bottom end portion 208, and forms an outer surface 210 and an inner surface 212 that extends between the top and bottom end portions.

A portion of the candle support 118 can form an alignment flange 214 that extends radially outward from the outer surface 210. The alignment flange 214 can be shaped as a ridge that extends along a perimeter of the outer surface 210. The ridge can be a continuous protrusion extending around the circumference of the candle support 118, or multiple protrusions spaced apart around the circumference of the candle support 118.

Optionally, the alignment flange 214 can be any structure or feature configured to engage another portion of the candle conversion device 100 to align the candle support 118 relative to the thermal sleeve 114. For example, the alignment flange 214 can be any of an outwardly extending tab, pin, recess, channel, and groove. Further, the alignment feature can be shaped as a slot or passage configured to receive a tab or pin that extends from the thermal sleeve 114 and/or the candle support 118.

The candle support 118 can have length L3 between the top and bottom end portions. The length L3 can be at least about 0.1 inches and/or less than or equal to about 2 inches. The alignment flange 214 can have a length L4, which extends along the outer surface 210 between the top and bottom end portions. The length L4 can be at least about 0.05 inches and/or less than or equal to about 0.5 inches. In some embodiments of the present disclosure, the candle support 118 has a length L3 of 0.5 inches, with an alignment flange 214 having a length L4 of 0.1 inches.

The inner surface 212 of the candle support extends between the top end portion 206 and the bottom end portion 208, and can form a portion of the drainage passage 204. Between the top and bottom end portions of the candle support 118, a cross-sectional width, between the inner surface 212 and the outer surface 210, can vary to form a drainage passage 204 with a tapering cross-sectional width. The width of the drain passage can taper between the top end portion 206 and the bottom end portion 208. The tapering cross-sectional width of the drainage passage 204 can be formed by a portion of the inner surface 204 tapering away from the outer surface 210, from the top end portion 206 toward the bottom end portion 208, as illustrated by the broken lines in FIG. 5. In some inventions of the present disclosure, the drainage passage 204 forms a funnel shape that tapers toward the bottom end portion 208.

At the bottom end portion 208 of the candle support, the inner surface 212 forms a bottom opening. The bottom opening permits melted wax to exit the drainage passage 204. At least some of the embodiments disclosed herein reflect the realization that candle conversion device 100 can have multiple drainage passages. Drainage passages can be formed as any of a channel, groove, opening, and lumen, or combination thereof. Optionally, a portion of the drainage passage can be formed by any of the inner and outer surfaces of the candle support 118, thermal sleeve 114, housing 108, and/or wax mold 112.

Between the outer surface 210 and the inner surface 212, the candle support 118 can have a hollow cross-section or solid cross-section. A solid cross-section provide mass for retaining and conducting thermal energy received from the thermal sleeve 114 and/or candle 104. As the melted wax is directed from the top end portion 206, toward the bottom end portion 208 of the candle support, thermal energy retained by the candle support 118 is transferred to the wax, thereby preventing the melted wax from solidifying before entering a wax mold coupled to the bottom opening.

The candle support 118 can have an interface ring 216 to engage a portion of the wax mold and align the bottom opening of the candle support 118 with an opening into the wax cavity of the wax mold. The interface ring 216 is shaped as a tube that extends away from the bottom end portion 208 of the candle support. An inner surface of the interface ring 216 forms a passage that is aligned with the bottom opening of the candle support 118 and coupled with the drainage passage 204.

Optionally, the interface ring 216 can be a ridge or protrusion that extends away from the candle support 118 to engage a portion of the wax mold. Alternatively, the interface ring 216 can include a recess or channel that extends into a portion of the candle support 118, such as the bottom surface 208 or drainage passage 204 to receive a portion of the wax mold. At least some of the embodiments disclosed herein reflect the realization that the interface ring 216 can have a cross-sectional profile that tapers toward or away from the bottom end portion of the housing to direct melted wax and/or provide an interference fitment between the candle support 118 and the wax mold 112.

The candle support 118 forms a candle engagement member 202 to retain a portion of the candle relative to the candle conversion device 100. The candle engagement member 202 is shaped as an arm 218 that extends from the candle support 118. The arm 218 can have a length that extends inward from the inner surface 212 toward the drainage passage 204, and a height that extends between the top and bottom end portions of the candle support 118.

In some embodiments of the present disclosure, two or more arms 218 extend radially inward from the inner surface 212. The arms 218 extend transverse relative to each other, intersecting in the drainage passage 204. The intersecting arms 218 divide the drainage passage 204 into a plurality of drainage passages. Optionally, the arms 218 can extend parallel to each other across a portion of the drainage passage 204.

In some embodiments of the present disclosure, four arms 218 extend radially inward from the inner surface 212 and form a top end surface of the candle support 118. The top end surface, formed by the arms 218 is planar to align a candle 104 that mounted to the candle support 118 relative to the candle conversion device 100. The candle is aligned when a bottom end surface of the candle 104 engages the top end surface of the arms 218. However, the top end surface of the arms 218 can form a convex or concave surface. The bottom end surface of the candle 104 can have a concave or convex surface that engages against the convex or concave surface of the candle support 118, and/or the bottom end surface of the candle 104 can be received into the concave surface of the candle support 118.

Optionally, an arm 218 has a proximal end portion coupled with the inner surface 212 and a distal end portion that extends away from the inner surface 212. The arm 218 can have a length from the inner surface 212 to a distal end that is less than the diameter or width of the drainage passage. Accordingly, the distal end portion of the arm does not extend across the drainage passage, thereby forming a space between the distal end of the arm 218 and the inner surface 212. In embodiments having more than one arm 218, a space or passage is formed between the distal ends of the arms. The passage between the distal ends of the arms 218 can permit melted wax to flow therethrough, and/or permit a portion of a candle to be inserted therein.

A protrusion 220 extends from away from the top end portion of the candle support 118 for mounting the candle 104 to the candle conversion device 100. The protrusion 220 can be shaped as a spike having a cross-sectional width that tapers away from the candle engagement member. When a candle is directed toward the candle support 118, the protrusion 220 pierces the candle, thereby restricting lateral movement of the candle 104 relative to the inner lumen 148 of the thermal sleeve.

At least some of the embodiments disclosed herein reflect the realization that the candle engagement member 202 can be any structure configured to mount a candle 104 to the candle conversion device 100. For example, the candle engagement member 202 can be shaped as any of a protrusion, a tab, and a pin configured to engage a portion of the candle 104. Further, a portion of the candle engagement member 202 can form any of a groove, a recess, and/or a cavity configured to receive a portion of the candle therein. Optionally, the candle 104 can comprise portions, such as protrusions and/or arms that extend radially outward to engage a portion of the thermal sleeve 114 and/or candle support 118.

The candle support 118 can be formed of one or more materials. The material can have a thermal conductivity that is favorable to conducting heat, such as aluminum, copper, or brass. In some embodiments of the present disclosure, the candle support 118 can be formed of a material that comprises a thermal conductivity that provides insulating characteristics, such as polyurethane, fiberglass, and silicone. At least some of the embodiments disclosed herein reflect the realization that the candle support 118 can comprise portions having different materials. For example, the inner surface 2 and/or candle engagement member 202 can comprise a conductive material to receive and direct thermal energy from the candle flame, while the outer surface 210 can comprise an insulating material to retain the energy received from the candle 104 and prevent conduction of the energy to the housing 108.

The thermal sleeve 114 and the candle support 118 can be coupled together as illustrated in FIG. 6. To couple the thermal sleeve 114 and the candle support 118, the top end portion 206 of the candle support is directed through the inner lumen 148 at the bottom end portion 144 of the thermal sleeve. The candle support 118 is moved into the inner lumen 148 until the alignment flange 214 engages the bottom end portion 144 of the thermal sleeve. When coupled together, a portion of the outer surface 210 of the candle support engages against the inner lumen 148. Further, a top surface of the alignment flange 214 engages against a bottom surface of the thermal sleeve 114. The surface portions of the thermal sleeve 114 and the candle support 118 that are engaged against each other permit conduction of thermal energy therebetween. Additionally, engagement of the alignment flange 214 against the thermal sleeve 114 restricts the depth to which the candle support 118 can be inserted into the inner lumen 148.

The length L5 of the outer surface 210 of the candle support engaged against the inner lumen 148 is at least about 0.1 inches and/or less than or equal to about 2 inches. Further, the length L5 can also be between about 0.25 inches and about 1 inch. In some inventions of the present disclosure, the candle support 118 is inserted into the inner lumen 148 with the length L5 of the outer surface 210 of the candle support engaged against the inner lumen 148 being 0.35 inch.

In some embodiments of the present disclosure, the thermal sleeve 114 and the candle support 118 are coupled together to have a length L6 between the top end portion 206 of the candle support and the top portion 142 of the thermal sleeve. The length L6 between the top end portions is at least about 0.1 inches and/or less than or equal to about 4 inches, or between about 0.25 inches and about 1 inch. In some inventions of the present disclosure, the length L6 is 0.7 inch.

Optionally, the length between the top end portion 206 of the candle support and the top portion 142 of the thermal sleeve can be expressed as a ratio. The ratio can describe the length of thermal sleeve 114 that extends above the top end portion 206 of the candle support. For example, at least about 5% and/or less than or equal to about 99% of the length L1 of the thermal sleeve 114 can extend above the top end portion 206 of the candle support. In some inventions of the present disclosure, 70% of the thermal sleeve 114 can extend above the top end portion 206 of the candle support. In some embodiments of the present disclosure, the entire thermal sleeve 114 can extend above the top end portion 206 of the candle support.

To secure a portion of the candle 104 within the thermal sleeve 114 and permit melted wax to move toward the wax mold, features of the candle support 118 are positioned relative to the thermal sleeve 114. Specifically, the candle engagement member 202 is positioned to intersect the inner lumen 148 to secure and/or mount a portion of the candle 104 within the thermal sleeve 114, and the drainage passage 204 is fluidly coupled with the inner lumen 148 to permit melted wax to move through the candle support 118.

The candle conversion device 100 can include a housing 108 to receive and align portions of the device relative to each other. In some inventions of the present disclosure, the housing 108 receives the thermal sleeve 114, the candle support 118, and the wax mold 112. A mold cavity 252 of the housing retains the wax mold 112, and aligns an opening into the wax cavity 122 with the drainage passage 204 of the candle support 118.

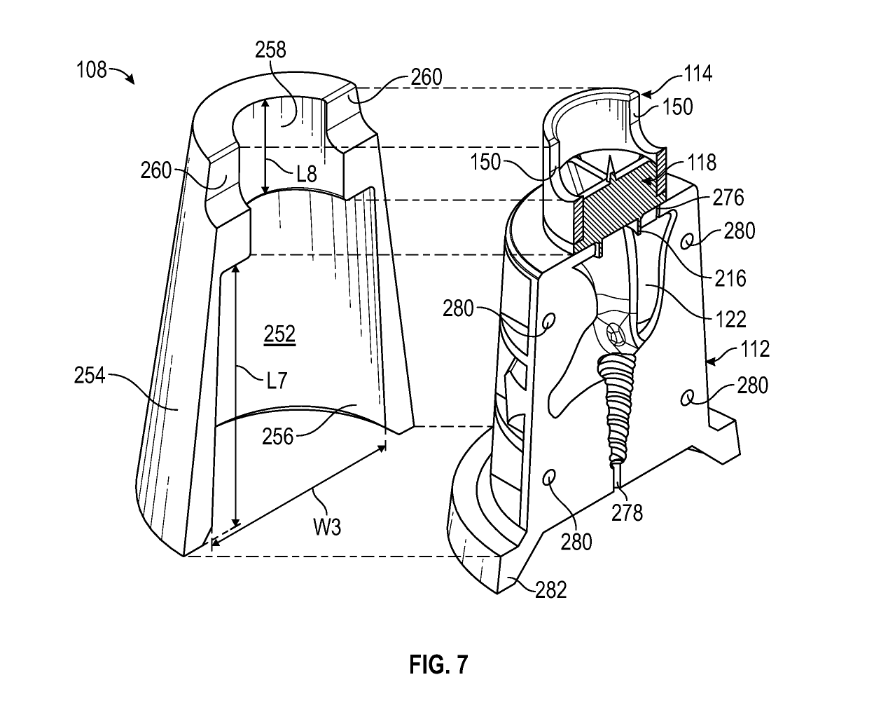

Referring to FIG. 7, the housing 108 is shaped as a body with a sidewall having an outer side surface 254 and an inner side surface 256. The inner side surface forms the mold cavity 252 to receive the wax mold 112 therein. A bore 258 extends through the housing 108 to the mold cavity 252 to receive the thermal sleeve 114 and the candle support 118 therein.

The mold cavity 252 extends inward, from an opening through an end portion of the housing 108. The opening permits the wax mold 112 to be inserted into the mold cavity 252. The inner side surface 252 of the housing that forms the mold cavity can have a cross-sectional profile with a width W3. The width W3 can be constant along a length of the mold cavity 252, or can comprise a width W3 that varies along the mold cavity 252. The width W3 of mold cavity 252 can vary by tapering from the opening toward the bore 258.

The width W3 of the mold cavity 252 can be at least about 0.5 inches and/or less than or equal to about 6 inches, or between about 1 inch and about 2.5 inches. In some devices of the present disclosure, width W3 of the mold cavity 252 tapers from about 2.5 inches to about 2 inches. A length L7 of the mold cavity 252, from the opening to the bore 258 can be at least about 0.5 inches and/or less than or equal to about 6 inches, or between about 2 inches and about 4 inches.

The bore 258 extends inward, through an end portion of the housing 108, toward the mold cavity 252. The bore 258 permits the thermal sleeve 114 and the candle support 118 to be inserted into the housing 108. A length L8 of the bore 258, from the top end portion of the housing 108 to the mold cavity 252 can be at least about 0.25 inches to 4 inches, or between about 0.5 inches and about 2 inches. In some embodiments of the present disclosure, the length L8 is about 1 inch, or about the same as the length L1 of the thermal sleeve 114.

Optionally, the thermal sleeve 114 and the candle support 118 can be inserted into the bore 258 in a direction from the mold cavity 252 toward the bore 258. In some inventions of the present application, the bore 258 can extend through a sidewall of the housing 108, and an aperture can intersect the bore 258. The thermal sleeve 114 and the candle support 118 can be inserted through the sidewall, such that the inner lumen 148 is aligned with the aperture, and a candle can be inserted the aperture toward the candle support 118.

A ventilation passage 260 of the housing can form a portion of the ventilation feature 126 of the candle conversion device 100. The ventilation passage 260 extends through the sidewall of the housing 108, between the outer side surface 254 and the bore 258. The ventilation passage 260 can extend from a top end portion toward the bottom end portion. Further, the housing 108 can have two or more ventilation passages 260. As illustrated in FIGS. 2 and 7, the ventilation passages 260 can extend along opposing portions of the housing 108.

The ventilation passage 260 has a shape that corresponds with the ventilation notch 150 of the conduction sleeve. When the conduction sleeve 114 is positioned in the bore 258, the ventilation notch 150 and ventilation passage 260 can be aligned together to permit movement of a gas between the ambient environment and the inner lumen 148. A length and width of the ventilation passage 260 can be about the same as the ventilation notch 150. Optionally, the ventilation passage 260 can be any opening or conduit that permits movement of a gas therethrough. For example, the ventilation passage 260 can be formed as an aperture or lumen through the housing 108. Further, the ventilation passage 260 can be formed as a channel that extends from the top end portion of the housing and along a surface of the bore 258 to permit movement of a gas between the top end portion of the housing 108 and the ventilation notch 150.

The housing 108 can be formed of one or more materials. The material can have a thermal conductivity that provides insulating characteristics, such as polyurethane, fiberglass, and silicone. In some embodiments of the present disclosure, the housing 108 can be formed of a material that comprises a thermal conductivity that is favorable to conducting heat, such as aluminum, copper, or brass. At least some of the embodiments disclosed herein reflect the realization that the housing 108 can comprise portions having different materials. For example, an inner side surface of the housing 108 can comprise a conductive material to receive and direct thermal energy, while an outer side surface of the housing 108 can comprise an insulating material to retain the energy received from the candle 104 and prevent conduction of the energy to the outer surfaces of the housing 108 where a user may touch the candle conversion device 100.

In some devices of the present disclosure, the candle conversion device 100 can comprise a portion of a housing. For example, a bottom end portion of the housing can extend only along a portion of a wax mold that is inserted into the mold cavity. Additionally, the housing 108 can have a length that extends only along the conduction sleeve 114 and candle support 118, and the wax mold 112 can be coupled to the bottom end portion of the housing 108 or the candle support 118. In some embodiments of the present disclosure, the housing 108, or portions thereof, are incorporated with each of the candle conversion device 100 portions. for example, a first portion of the housing can be coupled to the thermal sleeve 114 and/or candle support 118, and a second portion of the housing can be coupled to the wax mold, such that the first and second housing portions are joined together when any of the thermal sleeve 114, the candle support 118, and the wax mold 112 are assembled.

Optionally, in some embodiments of the present disclosure, the housing comprises a keyed alignment member configured to mate with a reciprocal keyed alignment member of the wax mold. The keyed alignment members of the housing 108 and wax mold 112 can be any of a protrusion and/or recess configured to mate together when the wax mold 112 inserted into the mold cavity 252 a specific distance or in a specific orientation.

When a wax mold 112, or portions thereof, are inserted into the tapered mold cavity 252, the inner side surface 256 can engage an outer surface of the wax mold 112 to create a friction fit. The friction fit between the housing 108 and the wax mold 112 prevents the wax mold 112 from separating from the housing 108 and can direct portions of the mold together. In some embodiments of the present disclosure, any of the housing 108, the wax mold 112, the conduction sleeve 114, and the candle support 118, and be coupled together by a friction fit, an adhesive, welding, a mechanical coupling, and/or any combination thereof.

The wax mold 112 is positioned in the mold cavity 252 so that the opening into the wax cavity 122 is aligned with the bore 258. When the conduction sleeve 114 and candle support 118 are positioned in the bore 258, the drainage 204 passages of the candle support are aligned with the opening into the wax cavity 122. The candle support 118 and wax mold 112 are oriented so that the interface ring 216 extends into the opening into the wax cavity 122.

Optionally, the housing 108 can be formed with moveable portions that can be moved or joined together to retain the candle conversion device 100 therein. For example, a portion of the housing 108 that encloses the mold cavity 252 can be separated to permit insertion of a wax mold 112. Once the wax mold 112 is placed into the mold cavity, the portion of the housing 108 can be reattached to secure the wax mold 112 therein.

The wax mold 112 is coupled with the candle conversion device 100 to receive melted wax into the wax cavity 122. The wax mold 112 can be shaped with an outer surface and an inner surface. A portion of the inner surface forming the wax cavity 122 comprises a shape profile. When the melted wax enters the wax cavity 122, the wax conforms to the shape profile of the wax cavity 122. Each wax mold 112 can have a different shape profile for the wax cavity 122, which can be an animal, a plant, a food, a structure, and/or a shape. For example, the shape profile can be any of a unicorn, an elephant, a pyramid, an Eiffel tower, a planet, a mushroom, a cupcake, and a star.

The wax mold 112 can include one or more wick channel for placement of a candle wick. The wick channel is shaped as a groove or passage in the wax mold 112. The wick channel permits a new candle wick to be coupled to the wax mold 112 and poisoned to extend through the wax cavity 122. When the wax solidifies in the wax cavity 122, the new candle wick will extend through the newly formed candle.

The wax mold 112 can have a first wick channel and a second wick channel. Generally, the position of the first and second wick channels, relative to the wax cavity 122, correspond to the bottom and top portions of the candle to be formed. Referring to FIG. 7, a portion of a wax mold 112 is illustrated with a first wick channel 276 adjacent to a top end portion of the wax mold 112, and a second wick channel 278 adjacent to a bottom end portion of the wax mold 112.

At least some of the embodiments disclosed herein reflect the realization that the profile of the wax cavity 122, and thus the candle that can be produced therefrom, can be oriented in any direction relative to the candle conversion device 100. Accordingly, a wick channel can be poisoned along a generally horizontal path across the wax cavity 122. Using the shape profile of a unicorn for example, the wax mold 112 can be formed with the neck and horn of the unicorn positioned horizontally, or transverse relative a length of the mold cavity 252, and the opening into the wax cavity 122 can extend into the mane of the unicorn. In this example, the wick can be placed between a horizontal wick channel that extends between the neck and horn of the unicorn.

Each portion of the wax mold 112 comprises a keyed alignment member 280 configured to mate with a reciprocal keyed alignment member. The keyed alignment members 280 of the wax mold can be any of a protrusion and/or recess configured to mate together when the first and second portions of the wax mold are joined together to enclose the wax cavity 122. In some embodiments of the present application, the portions of the wax mold 112 are joined together by any of an adhesive, a fastener, and friction fitment.

A flange 282 extends from a bottom end portion of the wax mold 112 to engage the bottom end portion of the housing 108 when the wax mold 112 is inserted into the mold cavity 252. The flange 282 extends radially outward away from the outer surface of the wax mold 112, and can have a width that is greater than the width W3 of the mold cavity 252. When the wax mold 112 is inserted into the mold cavity 252, the flange 282 extends along the bottom end portion of the housing 108 to the outer side surface 254.

The wax mold 112 is assembled with the candle conversion device 100 by first selecting a mold having the desired candle profile (e.g., a unicorn, an Eiffel tower, a star, or a sphere). A new candle wick is placed in the wick channel so that the wick extends across the wax cavity 122. The first and second portions of the wax mold 112 are then coupled together, thereby retaining the candle wick and enclosing the shape profile of the wax cavity 122. Next, the wax mold 112 is inserted into the mold cavity 252 until the flange 282 engages against the bottom end portion of the housing 108.

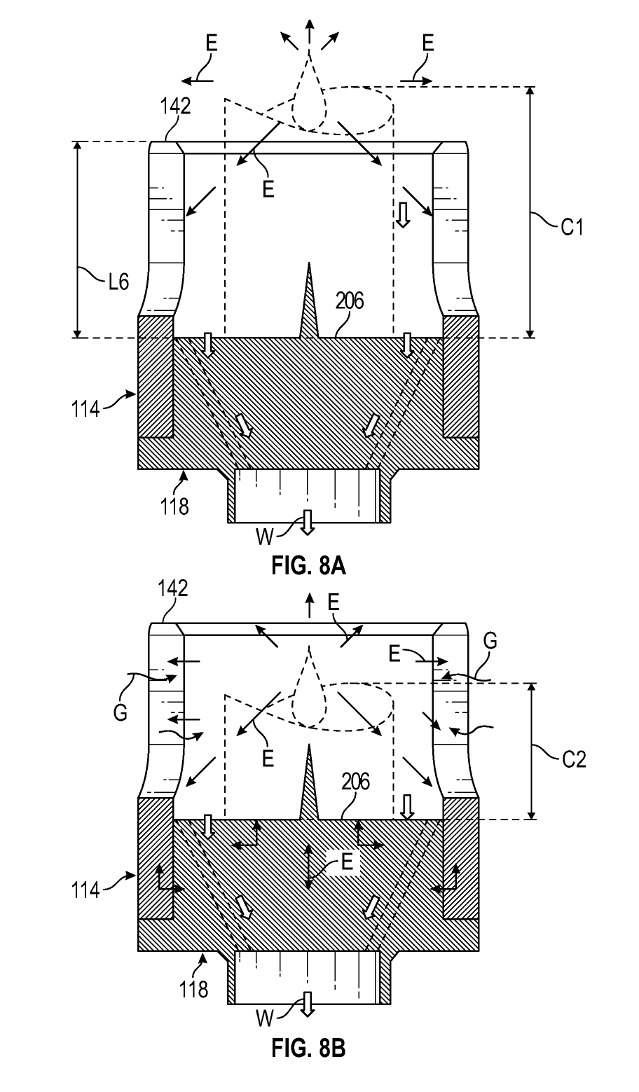

Referring to FIGS. 8A and 8B, movement of thermal energy E and a gas G, relative to a height of the candle 104, are illustrated.

The candle height is measured between the bottom end of the candle and the flame. FIG. 8A illustrates the candle 104 having a first height C1, and FIG. 8B illustrates the candle 104 having a second height C2. The height of the candle 104 can change from the first height C1 to the second height C2 as a result of the candle being consumed and the wax melting.

Referring to FIG. 8A, the first height C1 of the candle is about equal to or greater than the length L6 between the top end portion 206 of the candle support and the top portion 142 of the thermal sleeve 114. When the candle is the first height C1, a small portion of the thermal energy E from the flame is received by the thermal sleeve 114 and/or candle support 118. As the candle is consumed, melted wax moves in the direction of the arrows W and is directed through the drainage passage of the candle support 118.

Referring to FIG. 8B, the candle 104 has reduced in height to the second height C2. The second height C2 is about equal to or less than the length L6 between the top end portion 206 of the candle support and the top portion 142 of the thermal sleeve 114. When the candle is the second height C2, a greater portion of the thermal energy E from the flame, relative to when the candle is the first height C1, is received by the thermal sleeve 114 and/or candle support 118. The increased quantity of thermal energy E directed toward and absorbed by the thermal sleeve 114 and/or candle support 118 is illustrated by the greater quantity of arrows E. Further, when the candle is the second height C2, an increased quantity of thermal energy E is conducted between the thermal sleeve 114, the candle support 118, and the candle 104.

The thermal energy retained by the thermal sleeve 114 and the candle support 118 is directed to the candle 104 by conduction and/or radiation to ensure melted wax from the candle moves through the drainage passage before solidifying. In some instances of the present disclosure, the candle flame becomes extinguished when the candle wick is consumed, leaving some unmelted wax of the candle remaining. In at least some of the embodiments disclosed herein, the thermal energy conducted and/or radiated to the candle from the thermal sleeve 114 and/or the candle support 118 is sufficient to melt the remaining wax of the extinguished candle.

When the candle is the second height C2, the flame is positioned within the inner lumen 148 of the thermal sleeve 114, where the ambient oxygen can be consumed by the candle flame before additional oxygen is drawn into the inner lumen 148. If the oxygen is depleted by the candle before additional oxygen is moves into the thermal sleeve 114, the candle flame will become extinguished. However, the ventilation feature 126, which includes the ventilation notch 150 and the ventilation passage 260, permits gas from the environment ambient to the candle conversion device 100 to be drawn into the inner lumen 148, as illustrated by the curved arrows G.

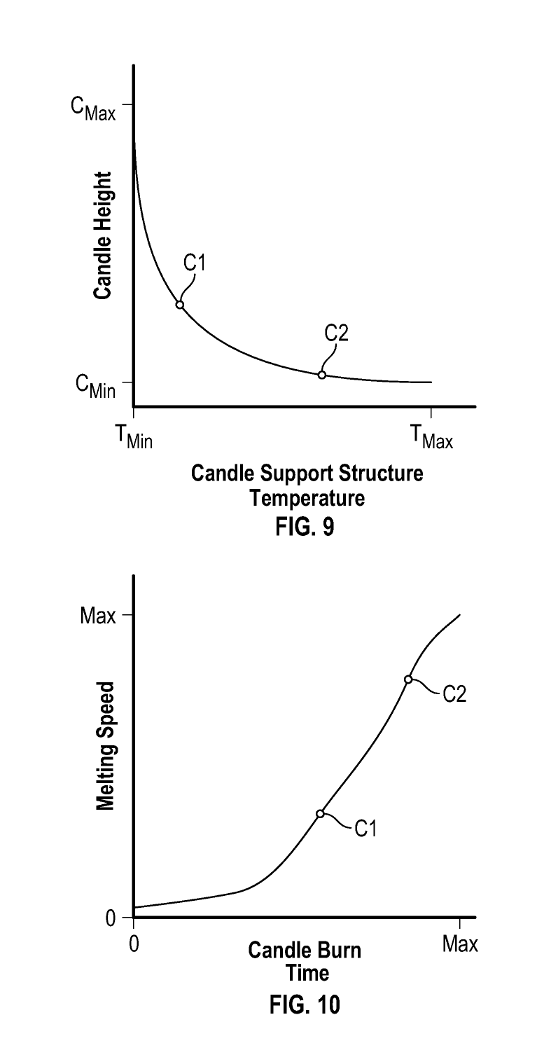

FIG. 9 is a graph illustrating the temperature of the candle support structure relative to the candle height. It should be understood that the candle support structure can include one or more portions of the candle conversion device, including the candle support and/or the conduction sleeve. When the candle is at a maximum height Cₘₐₓ, the temperature of the candle support is at a minimum temperature Tₘᵢₙ. The minimum temperature Tₘᵢₙ can be the ambient room temperature before the candle is lit, or when the distance between the candle flame and the candle conversion device results in no thermal energy being received by the candle conversion device.

As the candle is consumed, the height of the candle, and the distance between the candle flame and the candle support structure, is reduced. As the candle flame approaches to the candle support structure, for example, when the candle is the first height C1, the temperature of the candle support structure has increased. As the candle flame further approaches the candle support structure, for example, when the candle is the second height C2, the temperature of the candle support structure has increased further yet.

FIG. 10 is a graph illustrating the candle burn time relative to the candle melting speed. When the candle burn time is at zero (e.g., before being lit), the melting speed of the candle is zero. After the candle is lit, and when the distance between the candle flame and the candle conversion device results in no thermal energy being received by the candle conversion device, the melting speed of the candle is generally dependent upon the ambient room temperature, and/or the velocity of ambient air moving toward the candle flame. As the candle is consumed, and the candle flame approaches to the candle support structure (e.g., when the candle is the first height C1), the temperature of the candle support structure increases, thereby increasing the melting speed of the candle. As the candle flame further approaches the candle support structure, (e.g., when the candle is the second height C2), the temperature of the candle support structure and candle, and/or the velocity of ambient air moving toward the candle flame, has increased further yet, thereby further increasing the melting speed of the candle.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. A candle conversion device comprising: a thermal sleeve having a wall forming an inner lumen to receive at least a portion of a candle; and a candle support having a candle engagement member and a drainage passage to direct melted wax from the candle support toward a wax mold coupled to the candle conversion device, wherein the candle support is coupled to the thermal sleeve with the candle engagement member intersecting the inner lumen.

Clause 2. The candle conversion device of Clause 1, wherein the thermal sleeve comprises a ventilation channel extending between an area adjacent to an outer surface and the inner lumen to direct a gas therebetween.

Clause 3. The candle conversion device of any one of Clauses 1 or 2, wherein the ventilation channel extends through the wall of the thermal sleeve.

Clause 4. The candle conversion device of any one of Clauses 2 or 3, wherein the candle support is coupled to a first end portion of the thermal sleeve, and the ventilation channel extends through a second end portion of the thermal sleeve toward the first end portion.

Clause 5. The candle conversion device of any one of Clauses 1-4, wherein the inner lumen comprises a cross-sectional diameter that is about 25% larger than a diameter of a candle received therein.

Clause 6. The candle conversion device of any one of Clauses 1-5, wherein the candle support comprises an outer side surface and an inner side surface, the inner side surface forming at least a portion of the drainage passage.

Clause 7. The candle conversion device of Clause 6, wherein the inner side surface comprises a cross-sectional width that tapers from a top end portion toward a bottom end portion of the candle support.

Clause 8. The candle conversion device any one of Clauses 6 or 7, wherein a cross-sectional thickness of the wall increases, between the inner and outer side surfaces increases from a top end portion toward a bottom end portion of the candle support.

Clause 9. The candle conversion device of any one of Clauses 6-8, wherein the candle engagement member extends from the inner side surface into the drainage passage.

Clause 10. The candle conversion device of any one of Clauses 6-9, wherein the candle engagement member extends, from the inner side surface, across the drainage passage to form a plurality of drainage passages.

Clause 11. The candle conversion device of any one of Clauses 1-10, wherein the candle support comprises a protrusion extends from the candle engagement member to pierce a candle positioned in the inner lumen, the protrusion having a cross-sectional width that tapers away from the candle engagement member.

Clause 12. The candle conversion device of any one of Clauses 1-11, wherein the candle support comprises an alignment flange that extends radially outward from an outer surface of the wall to restrict movement of the candle support relative to the thermal sleeve.

Clause 13. The candle conversion device of any one of Clauses 1-12, wherein the candle support comprises a interface ring that extends from an outer surface of the candle support to engage against a wax mold so that an inner cavity of the wax mold is in fluid communication with the drainage passage.

Clause 14. The candle conversion device of Clause 13, wherein the interface ring comprises an inner circumferential surface that circumposes the drainage passage.

Clause 15. The candle conversion device of any one of Clauses 1-14, further comprising a housing having a mold cavity to receive a wax mold, and a bore extending from an outer surface of the housing into the mold cavity to permit insertion thereinto of the thermal sleeve and the candle support.

Clause 16. The candle conversion device of Clause 15, wherein the bore extends from a top end portion toward a bottom end portion of the housing, opposite the top end portion, and the mold cavity extends into the bottom end portion of the housing.

Clause 17. The candle conversion device of any one of Clauses 15 and 16, wherein an inner side surface of the housing, comprising the mold cavity, tapers from the bottom end portion toward the top end portion.

Clause 18. The candle conversion device of any one of Clauses 15-17, wherein the housing comprises a ventilation passage extending between an outer side surface of the housing and the bore to direct a gas toward the bore.

Clause 19. The candle conversion device of Clause 18, wherein the ventilation passage extends from the top end portion toward the bottom end portion of the housing.

Clause 20. A candle conversion device comprising: a thermal sleeve having a wall forming an inner lumen to receive at least a portion of a candle, and a candle support having a candle engagement member and a drainage passage, the candle engagement member intersecting the inner lumen to engage a portion of a candle positioned in the inner lumen; wherein the thermal sleeve and the candle support conduct energy received from a flame of the candle, and direct the energy to the candle, and melted wax is directed through the drainage passage from the candle support toward an inner cavity of a wax mold coupled to the candle conversion device.

Clause 21. The candle conversion device of Clause 20, wherein the thermal sleeve and the candle support are coupled together to conduct energy therebetween.

Clause 22. The candle conversion device of any of Clauses 20 and 21, wherein the energy received by the thermal sleeve and the candle support increases as a distance between the candle conversion device and the candle flame decreases.

Clause 23. The candle conversion device of any one of Clauses 20-22, wherein the energy conducted by the thermal sleeve and the candle support toward the candle increases as a distance between the candle conversion device and the candle flame decreases.

Clause 24. The candle conversion device of any one of Clauses 20-23, wherein the thermal sleeve and the candle support comprise a first temperature when a lit candle coupled thereto is a first length, and a second temperature when the lit candle is a second length, and wherein the first temperature is less than the second temperature, and the first length is greater than the second length.

Clause 25. The candle conversion device of any one of Clauses 20-24, wherein thermal sleeve comprises a ventilation channel to direct a gas between an area adjacent to an outer surface and the inner lumen.

Clause 26. The candle conversion device of claim 25, wherein a volume of gas directed through the ventilation channel toward the inner lumen increases as a distance between the candle conversion device and the candle flame decreases.

Clause 27. The candle conversion device of any one of Clauses 25 and 26, wherein the ventilation channel extends through the wall of the thermal sleeve.

Clause 28. The candle conversion device of any one of Clauses 20-27, wherein the candle support comprises an outer side surface and an inner side surface, the inner side surface forming at least a portion of the drainage passage.

Clause 29. The candle conversion device of any one of Clauses 20-28, wherein the candle support comprises a protrusion extends from the candle engagement member to pierce a candle positioned in the inner lumen, the protrusion having a cross-sectional width that tapers away from the candle engagement member.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

In one or more aspects, the terms “about,” “substantially,” and “approximately” may provide an industry-accepted tolerance for their corresponding terms and/or relativity between items, such as from less than one percent to 10 percent.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A candle conversion device comprising:
a thermal sleeve having a wall forming an inner lumen to receive at least a portion of a candle; and
a candle support having a candle engagement member and a drainage passage to direct melted wax from the candle support toward a wax mold coupled to the candle conversion device, wherein the candle support is coupled to the thermal sleeve with the candle engagement member intersecting the inner lumen.

2. The candle conversion device of claim 1, wherein the thermal sleeve comprises a ventilation channel extending between an area adjacent to an outer surface and the inner lumen to direct a gas therebetween.

3. The candle conversion device of claim 2, wherein the ventilation channel extends through the wall of the thermal sleeve.

4. The candle conversion device of claim 2, wherein the candle support is coupled to a first end portion of the thermal sleeve, and the ventilation channel extends through a second end portion of the thermal sleeve toward the first end portion.

5. The candle conversion device of claim 1, wherein the inner lumen comprises a cross-sectional diameter that is about 25% larger than a diameter of a candle received therein.

6. The candle conversion device of claim 1, wherein the candle support comprises an outer side surface and an inner side surface, the inner side surface forming at least a portion of the drainage passage.

7. The candle conversion device of claim 6, wherein the candle engagement member extends from the inner side surface into the drainage passage.

8. The candle conversion device of claim 6, wherein the candle engagement member extends, from the inner side surface, across the drainage passage to form a plurality of drainage passages.

9. The candle conversion device of claim 1, wherein the candle support comprises an alignment flange that extends radially outward from an outer surface of the wall to restrict movement of the candle support relative to the thermal sleeve.

10. The candle conversion device of claim 1, further comprising a housing having a mold cavity to receive a wax mold, and a bore extending from an outer surface of the housing into the mold cavity to permit insertion thereinto of the thermal sleeve and the candle support.

11. The candle conversion device of claim 10, wherein the housing comprises a ventilation passage extending between an outer side surface of the housing and the bore to direct a gas toward the bore.

12. A candle conversion device comprising:
a thermal sleeve having a wall forming an inner lumen to receive at least a portion of a candle, and a candle support having a candle engagement member and a drainage passage, the candle engagement member intersecting the inner lumen to engage a portion of a candle positioned in the inner lumen;
wherein the thermal sleeve and the candle support conduct energy received from a flame of the candle, and direct the energy to the candle, and melted wax is directed through the drainage passage from the candle support toward an inner cavity of a wax mold coupled to the candle conversion device.

13. The candle conversion device of claim 12, wherein the thermal sleeve and the candle support are coupled together to conduct energy therebetween.

14. The candle conversion device of claim 12, wherein the energy received by the thermal sleeve and the candle support increases as a distance between the candle conversion device and the candle flame decreases.

15. The candle conversion device of claim 12, wherein the energy conducted by the thermal sleeve and the candle support toward the candle increases as a distance between the candle conversion device and the candle flame decreases.

16. The candle conversion device of claim 12, wherein the thermal sleeve and the candle support comprise a first temperature when a lit candle coupled thereto is a first length, and a second temperature when the lit candle is a second length, and wherein the first temperature is less than the second temperature, and the first length is greater than the second length.

17. The candle conversion device of claim 12, wherein the candle support comprises an outer side surface and an inner side surface, the inner side surface forming at least a portion of the drainage passage.

18. The candle conversion device of claim 12, wherein the thermal sleeve comprises a ventilation channel to direct a gas between an area adjacent to an outer surface and the inner lumen.

19. The candle conversion device of claim 18, wherein a volume of gas directed through the ventilation channel toward the inner lumen increases as a distance between the candle conversion device and the candle flame decreases.

20. The candle conversion device of claim 18, wherein the ventilation channel extends through the wall of the thermal sleeve.
